(19) United States
(12) Patent Application Publication
(10) Pub. No.: US 2006/0182413 A1
(43) Pub. Date: Aug. 17, 2006

(54) Filming and recording apparatus and filming and recording method

(75) Inventor: Tai Yanazume, Yokohama-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/330,216

(22) Filed: Jan. 12, 2006

(30) Foreign Application Priority Data
Feb. 17, 2005 (JP) P2005-040324

(51) Int. Cl. H04N 5/91

(52) U.S. Cl. 386/68

(57) ABSTRACT

A filming and recording apparatus for filming and recording moving pictures and sound includes: a temporary moving picture storage area and a temporary sound storage area, for recording encoded data obtained for moving pictures and sound; a multiplexer, for multiplexing the data encoded for the moving pictures and the sound that are stored in the temporary moving picture storage area and the temporary sound storage area and for generating a moving picture/audio data file; and a long-term storage area, for storing the moving picture/audio data file, wherein the multiplexer multiplexes the encoded data obtained from the temporary moving picture storage area and the temporary sound storage area by tracing the encoded data backward from a stop filming instruction time.

### BACKGROUND OF THE INVENTION

1. Field of the Invention

The present invention relates to a filming and recording apparatus and a filming and recording method for filming and recording a moving picture and sounds.

2. Description of the Related Art

Since high compression encoding technologies such as MPEG-4 have been practically implemented, apparatuses used for filming and recording moving pictures and sounds can be made more compactly, and the availability of electronic apparatuses, such as digital cameras and cellular telephones, on which filming and recording apparatuses are mounted has spread.

Opportunities to take photographs have become more common, and the use of apparatuses for filming and recording moving pictures and sounds has shifted from conventional apparatuses, those that employ tape devices, to apparatuses that employ hard disks or flash memories. Such presently available filming and recording apparatuses have excellent characteristics, and large memory capacities and preferable access speeds, for example, and the ability to simultaneously perform writing/reading.

For apparatuses that record pictures for television, recording methods for effectively utilizing the characteristics of the large memory capacities available with recording apparatuses are frequently proposed; e.g., a time staggered playing function, a simultaneous, two-channel recording function and a function (see, for example, JP-A-2004-153791 (pp. 7-21, FIG. 1)) that can record a program desired by a user even when a recording start designated location has been shifted slightly. However, compared with the above described progress in the development of filming and recording apparatuses, such as digital cameras and digital movies, almost no comparable usage method has been proposed. That is, the basic employment method, whereby all data obtained from the start to the end of a filming are recorded, has remained unchanged since the advent of apparatuses that use tape devices.

A conventional filming and recording apparatus constitutes a system whereby, within a period extending from the reception of a start photographing instruction to the reception of a stop photographing instruction, the moving picture data and audio data that are received are recorded. Therefore, in order to appropriately limit the amount of data that are to be recorded, a cameraman must start filming immediately before an event to be filmed (hereinafter referred to as a photographic event) occurs.

However, when it is difficult to predict the start of a photographic event, e.g., when the moment an animal or a child, currently at rest begins to move is to be filmed, the actual filming process must be begun considerably before the event occurs. While disregarding cases wherein anticipated events occur immediately after filming begins, if events do not occur soon after the filming has begun, recorded portions will be generated that contain an enormous amount of unnecessary data.

This problem will be explained more specifically. FIG. 8 is a schematic diagram showing the relation between a desired recorded portion and a redundant recorded portion photographed for a moving picture.

Assume that it is desired that the moment a child stands up be recorded as a moving picture/audio data file consisting of at most three frames. Note that hereinafter, data obtained by multiplexing moving picture data and audio data is called moving picture/audio data.

When frames 303 to 305 are to be filmed and recorded using a conventional apparatus, a cameraman, who can not predict whether the child will stand up at the point shown in the frame 303, must continue to press a start button beginning at the point shown in frame 300, for example. Thus, when the start button is pressed at the point shown in frame 300, the redundant scenes in the frames 300 to 302 are recorded in the moving picture/audio data file. This redundant recorded data can become a critical problem, especially as regards the period of time that can be used for playback and the limited data memory capacity available, when data are to be transmitted using a portable communication device.

To resolve this problem, a method has been proposed whereby a moving picture/audio data file is edited following a filming session; however, excessive time is required to perform the editing operation, which is complicated. Actually, a filming and recording apparatus is available that has such a moving picture editing function, but the unit is not generally popular.

When to reduce the recorded portion redundancy the filming start time is delayed, the opportunity to film an event could be lost. As described above, the time at which filming is started is an important matter for a cameraman who desires to film and record an event that will only momentarily be available.

### SUMMARY OF THE INVENTION

While taking the conventional shortcomings into account, one objective of the present invention is to provide a filming and recording apparatus that can record data that precisely depict a desired event, and a filming and recording method therefor.

According to the invention, a filming and recording apparatus for filming and recording moving pictures and sound comprises:

a first storage unit, for recording encoded data obtained for moving pictures and sound;

a multiplexing unit, for multiplexing the data encoded for the moving pictures and the sound that are stored in the first storage unit and for generating a moving picture/audio data file; and

a second storage unit, for storing the moving picture/audio data file,

wherein the multiplexing unit multiplexes the encoded data obtained from the first storage unit by tracing the encoded data backward from a stop filming instruction time.

According to this arrangement, the multiplexing unit multiplexes the encoded data obtained from the first storage unit by tracing the encoded data backward from the stop filming instruction time. Thus, since data can be recorded while using the end point for the photographic event as a reference, data that precisely depict the photographic event can be recorded, while eliminating, to the extent possible, the recording of unnecessary data obtained prior to the occurrence of the photographic event.

Furthermore, according to the invention, a filming and recording apparatus, for filming and recording moving pictures and sound, comprises:

a first storage unit, for recording encoded data obtained for moving pictures and sound;

an automatic picture/sound deletion unit, for, when the encoded data for the moving pictures and the sound stored in the first storage unit exceed in size an amount equivalent to the timing for a predesignated recording period or to a predesignated data capacity, deleting from the oldest data the excessive encoded data for the moving pictures and the sound;

a multiplexing unit, for multiplexing the encoded data for the moving pictures and the sound that are stored in the first storage unit and for generating a moving picture/audio data file; and

a long-term storage unit, for storing the moving picture/audio data file,

wherein the multiplexing unit multiplexes the encoded data that are obtained from the first storage unit by tracing the encoded data backward from a stop filming instruction time.

According to this arrangement, data for pictures can be recorded that precisely depict a photographic event.

The filming and recording apparatus of the invention further comprises:

a head picture information providing unit, for obtaining data for a picture from the last encoded data for the moving pictures and the sound that are deleted by the automatic picture/sound deletion unit and for providing the data for the picture as information for a head picture related to the moving picture/audio data file to be generated.

According to this arrangement, data for pictures that precisely depict a photographic event can be recorded, while a filming and recording interval can be identified.

For the filming and recording apparatus of the invention, the automatic picture/sound deletion unit regards as a single deletion unit a time period that is the equivalent of one frame, and for each deletion unit, synchronously deletes the encoded data for the moving pictures and the sound.

With this arrangement, a moving picture/audio data file can be generated in which a photographic event is precisely depicted.

For the filming and recording apparatus of the invention, the automatic picture/sound deletion unit regards integer times a period for one frame as a single deletion unit, and for each deletion unit, synchronously deletes the encoded data for the moving pictures and the sound.

With this arrangement, a moving picture/audio data file can be generated in which a photographic event is precisely depicted.

Further, in accordance with a moving picture/audio data file reproduction unit that is to be connected, the filming and recording apparatus of the invention automatically designates an optimal data encoding method for the reproduction performed by the reproduction unit and a recording period or a data capacity for the moving picture/audio data file that is to be generated.

With this arrangement, the setup related to a moving picture/audio data file to be generated can be performed that can produce data that precisely depict the photographic event.

Furthermore, for the filming and recording apparatus of the invention, the multiplexing unit multiplexes the encoded data for the moving pictures and the sound at a point reached by proceeding backward for a predesignated period of time or for a period that corresponds to a predesignated amount of data.

With this arrangement, a moving picture/audio data file can be generated in which a photographic event is precisely depicted.

According to the invention, a filming and recording method for filming and recording moving pictures and sound comprises:

a first storage step of recording encoded data for moving pictures and sound that are entered;

a multiplexing step of multiplexing the encoded data for moving pictures and sound that are stored at the first storage step and for generating a moving picture/audio data file; and

a second storage step of storing the moving picture/audio data file,

whereby at the multiplexing step, the encoded data that are obtained by tracing the encoded data backward from a stop filming instruction time are multiplexed.

Furthermore, according to the invention, a filming and recording method for filming and recording moving pictures and sound comprises:

a first storage step of recording encoded data for the moving pictures and the sound that are entered;

an automatic picture/sound deletion step of, when the encoded data for the moving pictures and the sound stored at the first storage step exceed in size an amount that is equivalent to the timing for a predesignated recording period or to a predesignated data capacity, deleting from the oldest data the excessive amount of encoded data for the moving pictures and the sound;

a multiplexing step of multiplexing the encoded data for the moving picture and the sound that are stored at the first storage step and of generating a moving picture/audio data file; and

a second storage step of storing the moving picture/audio data file,

whereby, at the multiplexing step, the encoded data that are obtained by tracing the encoded data backward from a stop filming instruction time are multiplexed.

The filming and recording method of the invention further comprises:

a head picture information providing step of obtaining data for a picture from the last encoded data for the moving pictures and the sound that are deleted at the automatic picture/sound deletion step and of providing the data for the picture as information for a head picture related to the moving picture/audio data file to be generated.

According to the invention, complicated operations, such as the editing of data after filming has been completed and the repeated filming of a scene to obtain desired pictures, are not required, and a moving picture/audio data file can be created in which a photographic event is precisely depicted.

Further, since a moving picture/audio data file that includes a desired photographic event can be generated simply by issuing an appropriate end filming instruction, a cameraman can film a scene without worrying about when to start the filming and whether there has been an increase in the recording of redundant data.

### BRIEF DESCRIPTION OF THE DRAWINGS

FIG. 1 is a block diagram showing the internal configuration of a filming and recording apparatus according to a first embodiment of the present invention.

FIG. 2 is a flowchart showing the filming and recording operation performed by the filming and recording apparatus according to the first embodiment of the invention.

FIG. 3 is a block diagram showing the internal configuration of a filming and recording apparatus according to a second embodiment of the present invention.

FIG. 4 is a flowchart showing the filming and recording operation performed by the filming and recording apparatus according to the second embodiment of the invention.

FIG. 5 is a block diagram showing the internal configuration of a filming and recording apparatus according to a third embodiment of the present invention.

FIG. 6 is a flowchart showing the filming and recording operation performed by the filming and recording apparatus according to the third embodiment of the invention.

FIG. 7 is a schematic diagram showing an example synthesized image, displayed on a filming display unit, of a recently taken picture and a picture transmitted by a deleted picture transmitter.

FIG. 8 is a schematic diagram showing the relative positioning, during the filming of a moving picture, of a desired recorded portion and a redundant recorded portion.

### DESCRIPTION OF THE PREFERRED EMBODIMENTS

A filming and recording apparatus according to the preferred embodiments of the present invention will now be described in detail while referring to the accompanying drawings.

### First Embodiment

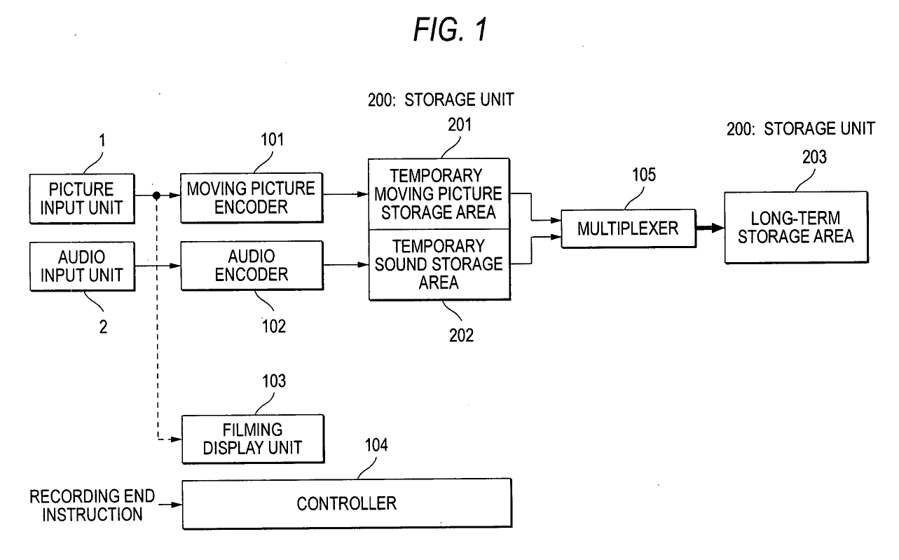

FIG. 1 is a block diagram showing the internal configuration of a filming and recording apparatus according to a first embodiment of the present invention.

The filming and recording apparatus includes: a picture input unit 1, an audio input unit 2, a moving picture encoder 101, an audio encoder 102, a filming display unit 103, a controller 104, a multiplexer 105 and a storage unit 200. The storage unit 200 includes a temporary moving picture storage area 201, a temporary sound storage area 202 and a long-term storage area 203.

The picture input unit 1, which is, for example, a well known digital camera unit, generates moving picture data and transmits the data to the moving picture encoder 101 and the filming display unit 103.

The audio input unit 2, which is, for example, a well known microphone unit, generates audio data and transmits the audio data to the audio encoder 102.

The moving picture encoder 101 encodes the moving picture data received from the picture input unit 1 by using an encoding method designated during the initial setup of the controller 104. The encoded moving picture data are transmitted to and stored in the temporary moving picture storage area 201.

The audio encoder 102 encodes the audio data received from the audio input unit 2 by using an encoding method designated during the initial setup of the controller 104. The encoded audio data are transmitted to and stored in the temporary sound storage area 202.

The filming display unit 103, which is, for example, a liquid crystal display unit or an organic EL display unit, displays the moving picture data received from the picture input unit 1 or a head picture for a moving picture/audio data file that will be described later. A cameraman visually identifies a picture on the display, and can confirm the current filming target or the first picture to be recorded.

The controller 104 is constituted, for example, by a CPU and controls the overall operation of the filming and recording apparatus. Various operations can be provided when the controller 104 executes a control program that has been stored, in advance, and various initial setups can also be changed as a result of entries made by a cameraman.

The storage unit 200 is a memory in which moving picture data and audio data, or a moving picture/audio data file, obtained by multiplexing the moving picture data and the audio data, is stored. The storage unit 200 has three areas, the temporary moving picture storage area 201, the temporary sound storage area 202 and the long-term storage area 203. These areas can also be employed as separate storage areas.

The multiplexer 105 multiplexes the moving picture data stored in the temporary moving picture storage area 201 and the audio data stored in the temporary sound storage area 202, and generates a moving picture/audio data file. The thus generated multiplexed data are stored in the long-term storage area 203.

The operation of the filming and recording apparatus having this arrangement will now be explained.

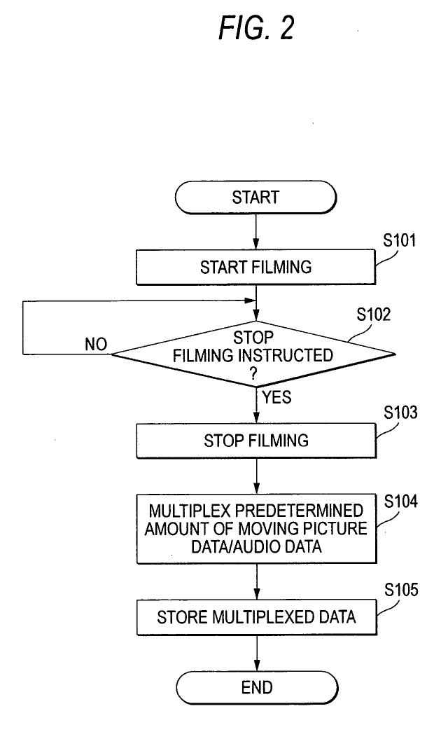

FIG. 2 is a flowchart showing the filming and recording operations performed by the filming and recording apparatus according to the first embodiment of the invention. When a cameraman enters a start filming instruction by pressing the start button, for example, of the filming and recording apparatus, the filming process is started (step S101). The cameraman can then film a desired event, while confirming pictures displayed on the filming display unit 103.

When the cameraman confirms that the filming of the desired event has been completed and immediately thereafter enters a stop filming instruction by pressing the filming stop button of the filming and recording apparatus (step S102), the controller 104 halts the filming (step S103) and issues a command to the multiplexer 105 to multiplex data having a size equivalent to the timing for a predesignated recording period or to a predesignated data capacity, beginning at the latest data.

Upon receiving this command, the multiplexer 105 multiplexes the data in the temporary moving picture storage area 201, the moving picture data, and in the temporary audio storage area 202, the audio data, having a size equivalent to the timing for the predetermined recording period or to the predetermined data capacity (step S104), and stores the multiplexed data in the long-term storage area 203 (step S105).

The data multiplexed by the multiplexer 105 are those extending back a distance, from the halt filming instruction point, the equivalent of the timing for the predesignated recording period or of the predesignated data capacity. Therefore, a moving picture/audio data file having a constant size can always be recorded in the long-term storage area 203.

The moving picture/audio data file generated by the filming operation will now be specifically explained while referring to FIG. 8, which is used for the explanation of the background art.

Assume, as in the conventional case, it is desired that the moment a child stands up be recorded as a moving picture/audio data file.

Since the timing for the period or the data capacity allocated for a moving picture/audio data file to be recorded can be designated, in advance, for the filming and recording apparatus of this embodiment, initially, the filming of three frames, for example, is designated for the moving picture/audio data file. The cameraman starts filming and continues until the filming of the desired event (in this case, the standing up activity) has been completed. Immediately after the desired event has been filmed, the cameraman enters a stop filming instruction by pressing the stop filming button.

When, for example, the filming is started at frame 301 and the stop filming instruction is entered at frame 305, immediately after the subject stood up, the pictures and sounds obtained for frames 301 to 305 are recorded in the temporary moving picture storage area 201 and the temporary sound storage area 202. However, the moving picture/audio data that is stored as a moving picture/audio data file in the long-term storage area 203 is the data for the frame 305 and the two preceding frames, i.e., the data for frames 303 through 305. Therefore, a moving picture/audio data file can be generated in which a photographic event is precisely depicted.

### Second Embodiment

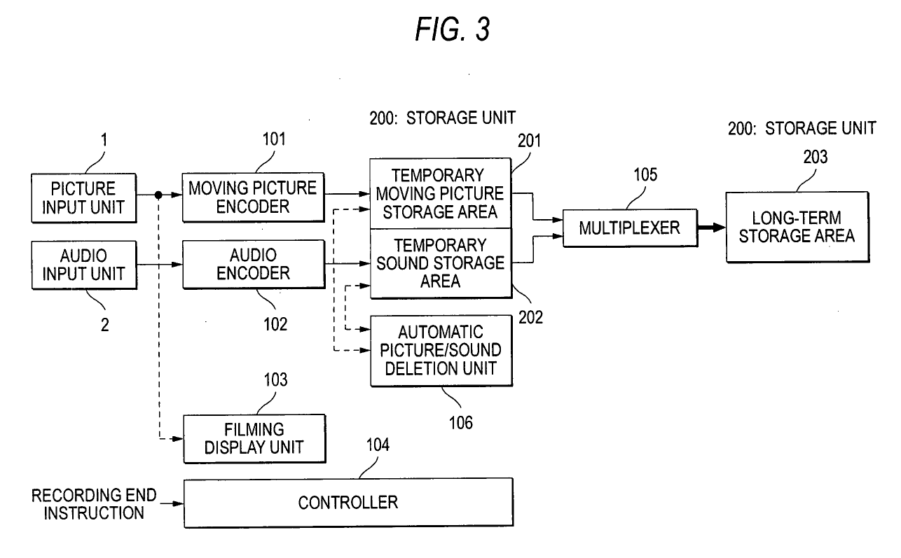

FIG. 3 is a block diagram showing the internal configuration of a filming and recording apparatus according to a second embodiment of the present invention.

Compared with the filming and recording apparatus of the first embodiment, the filming and recording apparatus of the second embodiment additionally includes an automatic picture/sound deletion unit 106.

Based on the timing for a recording period or on a recording capacity that is designated during the initial setup of the controller 104, the automatic picture/sound deletion unit 106 monitors moving picture data and audio data respectively stored in the temporary moving picture storage area 201 and the temporary sound storage area 202, and when the data volume exceeds in size an amount equivalent to the timing for a predetermined recording period or to a predetermined recording capacity, simultaneously deletes moving picture data and audio data, beginning with the oldest. Since the remainder of the configuration and the functions thereof are the same as those in the first embodiment, no further explanation for them will be given.

The operation of the filming and recording apparatus having this configuration will now be described.

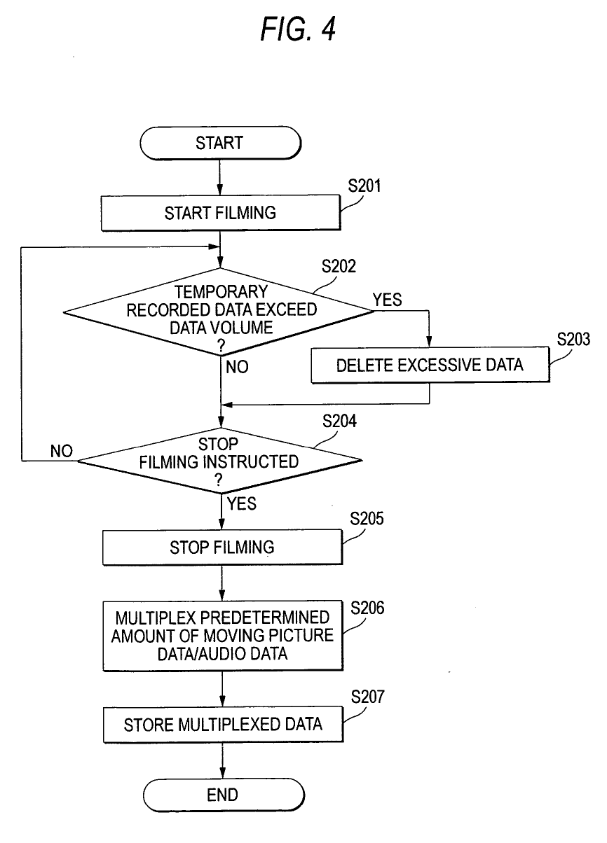

FIG. 4 is a flowchart showing the filming and recording operations performed by the filming and recording apparatus of the second embodiment of the invention. When a cameraman enters a start filming instruction by pressing the start filming button of the filming and recording apparatus, filming is begun (step S201). The cameraman the performs the filming of a desired event, while visually examining pictures displayed on the filming display unit 103.

During the filming, the automatic moving picture/sound deletion unit 106 monitors the amount of moving picture data and the amount of audio data that are recorded (step S202), and when the data volume exceeds in size an amount equivalent to the timing for a predesignated recording period or to a predesignated recording capacity, simultaneously deletes moving picture data and audio data, beginning with the oldest (step S203).

When the cameraman confirms that the filming of the desired event has been completed and immediately thereafter enters a stop filming instruction by pressing the stop filming button of the filming and recording apparatus (step S204), the controller 104 halts the filming (step S205) and issues a command to the multiplexer 105 to multiplex the data stored in the temporary moving picture storage area 201 and the temporary sound storage area 202, beginning with the latest data.

Upon receiving this command from the controller 104, the multiplexer 105 multiplexes the data in the temporary moving picture storage area 201, the moving picture data, and in the temporary sound storage area 202, the audio data (step S206), and stores the multiplexed data in the long-term storage area 203 (step S207).

Since moving picture data and audio data exceeding in size an amount equivalent to the timing for the predetermined recording period or to the predetermined data capacity are automatically deleted, in advance, by the automatic moving picture/sound deletion unit 106, a moving picture/audio data file having a constant size can always be multiplexed by the multiplexer 105 and stored in the long-term storage area 203.

According to the filming and recording apparatus of the first embodiment, a storage area having a large memory capacity is required because data are continuously accumulated in the temporary moving picture storage area 201 and the temporary sound storage area 202 until the filming stop instruction is issued. Whereas in accordance with the filming and recording apparatus of the second embodiment, since the automatic picture/sound deletion unit 106 automatically deletes redundant data, a savings in the memory capacity of the storage unit 200 can be realized.

### Third Embodiment

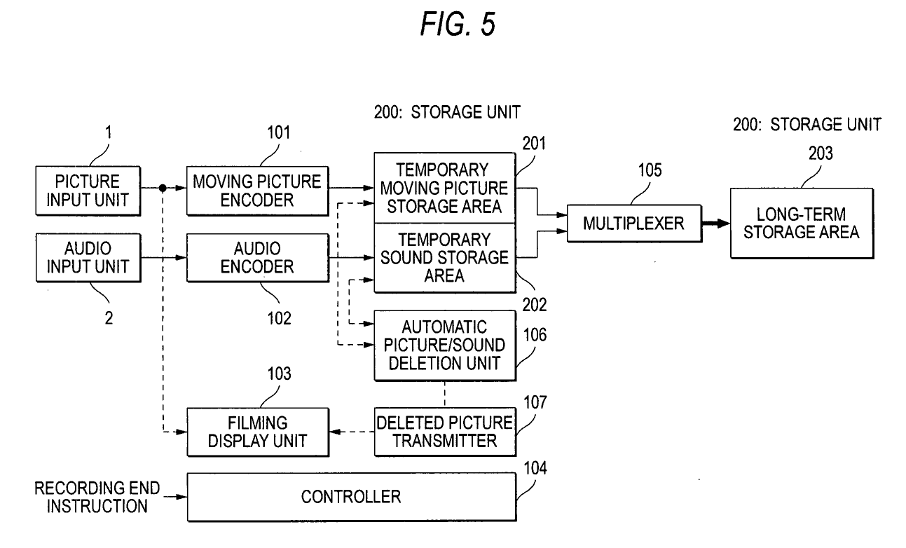

FIG. 5 is a block diagram showing the internal configuration of a filming and recording apparatus according to a third embodiment of the present invention.

Compared with the filming and recording apparatus for the second embodiment, the filming and recording apparatus for the third embodiment additionally includes a deleted picture transmitter 107.

A deleted picture transmitter 107 transmits, to the filming display unit 103, data for the last picture that was deleted by the automatic picture/sound deletion unit 106. On the filming display unit 103, the picture transmitted by the deleted picture transmitter 107 is displayed along with a currently taken picture. This last deleted picture is used as the head picture (strictly, an extremely similar picture) for a moving picture/audio data file that is to be generated when the filming at this time is halted. Since the remainder of the configuration and the functions thereof are the same as those for the second embodiment, no further explanation for them will be given.

The operation of the filming and recording apparatus having this configuration will now be described.

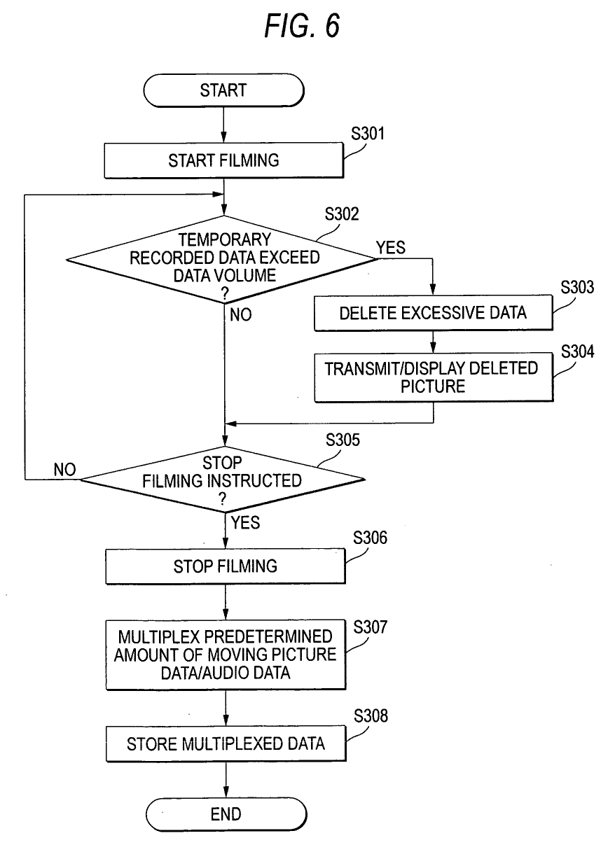

FIG. 6 is a flowchart showing the filming and recording operations performed by the filming and recording apparatus of the third embodiment of the invention. When a filming start instruction is entered by a cameraman by pressing the filming start button of the filming and recording apparatus, filming is begun (step S301). The cameraman then performs the filming of a desired event, while visually confirming pictures displayed on the filming display unit 103.

During the filming, the automatic moving picture/sound deletion unit 106 monitors the amount of moving picture data and the amount of audio data that are recorded (step S302), and when the data volume exceeds in size an amount equivalent to the timing for a predetermined recording period or to a predetermined data capacity that has been designated, in advance, deletes moving picture data and audio data, beginning with the oldest (step S303).

At the same time, the deleted picture transmitter 107 transmits data for the deleted picture to the filming display unit 103, and this picture (e.g., a picture that was taken a predetermined period before and is used as the head of a picture/audio data file) is synthesized with the most recently taken picture received from the picture input unit 1, and the synthesized picture is displayed on the filming display unit 103 (step S304).

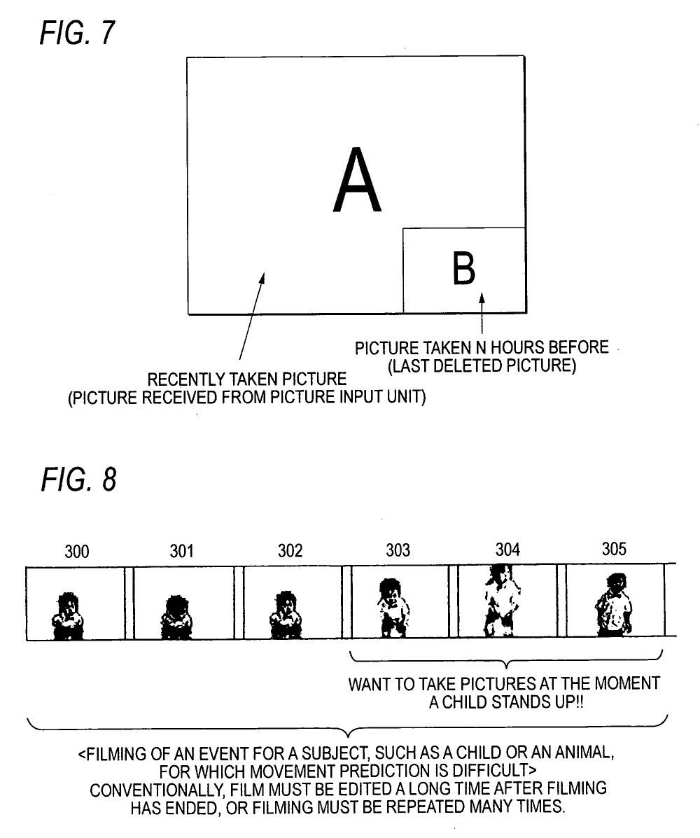

FIG. 7 is a schematic diagram showing an example synthesized picture, displayed on the filming display unit 103, of the most recently taken picture and a picture transmitted by the deleted picture transmitter 107. A cameraman need only visually examine the deleted picture and the recent picture to accurately understand from which point to which other point pictures in a moving picture/audio data file to be generated will cover. The positions and sizes of the recent picture and the deleted picture may be freely selected by the cameraman.

When the cameraman confirms that filming of the desired event has been completed, and issues a stop filming instruction by pressing the filming stop button of the filming and recording apparatus (step S305), the controller 104 halts the filming (step S306), and issues a command to the multiplexer 105 to multiplex data stored in the temporary moving picture storage area 201 and in the temporary sound storage area 202, beginning with the latest data.

Upon receiving this command from the controller 104, the multiplexer 105 multiplexes the moving pictures in the temporary moving picture storage area 201 and the audio data in the temporary sound storage area 202 (step S307), and stores the multiplexed data in the long-term storage area 203 (step S308).

According to the filming and recording apparatus of the third embodiment, as well as the filming and recording apparatus of the second embodiment, since moving picture and audio data that exceed in size the amount equivalent to the predetermined recording period or to the data capacity are automatically deleted, in advance, by the automatic moving picture/sound deletion unit 106, a moving picture/audio data file having a constant size can always be multiplexed by the multiplexer 105 and stored in the long-term storage area 203.

Furthermore, according to the filming and recording apparatus of the third embodiment, since the head picture of the moving picture/audio data to be generated can also be viewed with the most recently taken picture, the cameraman can record a picture that precisely depicts a photographic event, while identifying the filming and recording interval.

In these embodiments, the temporary moving picture storage area 201 and the temporary sound storage area 202 together function as a first storage unit and the long-term storage area 203 functions as a second storage unit in the storage unit 200 provided for the filming and recording apparatus. And the deleted image transmitter 107 and the filming display unit 103 together function as a head image information provision unit.

In the embodiments, for the data encoding performed for the controller 104 before filming begins and for the method used to set the timing for a filming period and to set a filming data capacity, a cameraman may directly designate individual parameters. Either this, or the cameraman may designate an apparatus to be used to reproduce a moving picture/audio data file that has been recorded, and the controller 104, by referring to a pre-registered table, may calculate either an optimal encoding method for the apparatus that reproduces the file or a method for calculating the timing for a filming period and a filming data capacity.

The present invention provides effects that enable the generation of a moving picture/audio data file in which photographic event is precisely depicted, and the filming and recording apparatus and the filming and recording method of this invention can effectively establish the conditions for the filming and recording of moving pictures and sounds.

What is claimed is:

1. A filming and recording apparatus for filming and recording moving pictures and sound, comprising:
a first storage unit, recording encoded data obtained for moving pictures and sound;
a multiplexing unit, multiplexing the data encoded for the moving pictures and the sound that are stored in the first storage unit and for generating a moving picture/audio data file; and
a second storage unit, storing the moving picture/audio data file;
wherein the multiplexing unit multiplexes the encoded data obtained from the first storage unit by tracing the encoded data backward from a stop filming instruction time.

2. A filming and recording apparatus, for filming and recording moving pictures and sound, comprising:
a first storage unit, recording encoded data obtained for moving pictures and sound;
an automatic picture/sound deletion unit, for, when the encoded data for the moving pictures and the sound stored in the first storage unit exceed in size an amount equivalent to the timing for a predesignated recording period or to a predesignated data capacity, deleting from the oldest data the excessive encoded data for the moving pictures and the sound;
a multiplexing unit, for multiplexing the encoded data for the moving pictures and the sound that are stored in the first storage unit and for generating a moving picture/audio data file; and
a long-term storage unit, for storing the moving picture/audio data file,
wherein the multiplexing unit multiplexes the encoded data that are obtained from the first storage unit by tracing the encoded data backward from a stop filming instruction time.

3. The filming and recording apparatus according to claim 2, comprising:
a head picture information providing unit, obtaining data for a picture from the last encoded data for the moving pictures and the sound that are deleted by the automatic picture/sound deletion unit and for providing the data for the picture as information for a head picture related to the moving picture/audio data file to be generated.

4. The filming and recording apparatus according to claim 2, wherein the automatic picture/sound deletion unit regards as a single deletion unit a time period that is the equivalent of one frame, and for each deletion unit, synchronously deletes the encoded data for the moving pictures and the sound.

5. The filming and recording apparatus according to claim 2, wherein the automatic picture/sound deletion unit regards integer times a period for one frame as a single deletion unit, and for each deletion unit, synchronously deletes the encoded data for the moving pictures and the sound.

6. The filming and recording apparatus according to claim 1, which, in accordance with a moving picture/audio data file reproduction unit that is to be connected, automatically designates an optimal data encoding method for the reproduction performed by the reproduction unit and a recording period or a data capacity for the moving picture/audio data file that is to be generated.

7. The filming and recording apparatus according to claim 2, which, in accordance with a moving picture/audio data file reproduction unit that is to be connected, automatically designates an optimal data encoding method for the reproduction performed by the reproduction unit and a recording period or a data capacity for the moving picture/audio data file that is to be generated.

8. The filming and recording apparatus according to claim 1, wherein the multiplexing unit multiplexes the encoded data for the moving pictures and the sound at a point reached by proceeding backward for a predesignated period of time or for a period that corresponds to a predesignated amount of data.

9. The filming and recording apparatus according to claim 2, wherein the multiplexing unit multiplexes the encoded data for the moving pictures and the sound at a point reached by proceeding backward for a predesignated period of time or for a period that corresponds to a predesignated amount of data.

10. A filming and recording method for filming and recording moving pictures and sound comprising:
a first storage step of recording encoded data for moving pictures and sound that are entered;
a multiplexing step of multiplexing the encoded data for moving pictures and sound that are stored at the first storage step and for generating a moving picture/audio data file; and
a second storage step of storing the moving picture/audio data file,
whereby at the multiplexing step, the encoded data that are obtained by tracing the encoded data backward from a stop filming instruction time are multiplexed.

11. A filming and recording method for filming and recording moving pictures and sound comprising:
a first storage step of recording encoded data for the moving pictures and the sound that are entered;
an automatic picture/sound deletion step of, when the encoded data for the moving pictures and the sound stored at the first storage step exceed in size an amount that is equivalent to the timing for a predesignated recording period or to a predesignated data capacity, deleting from the oldest data the excessive amount of encoded data for the moving pictures and the sound;
a multiplexing step of multiplexing the encoded data for the moving picture and the sound that are stored at the first storage step and of generating a moving picture/audio data file; and
a second storage step of storing the moving picture/audio data file,
whereby, at the multiplexing step, the encoded data that are obtained by tracing the encoded data backward from a stop filming instruction time are multiplexed.

12. A filming and recording method according to claim 10, further comprising:
a head picture information providing step of obtaining data for a picture from the last encoded data for the moving pictures and the sound that are deleted at the automatic picture/sound deletion step and of providing the data for the picture as information for a head picture related to the moving picture/audio data file to be generated.
